(19) United States
(12) Patent Application Publication
(10) Pub. No.: US 2010/0179699 A1
(43) Pub. Date: Jul. 15, 2010

(54) METHOD AND ELECTRONIC DEVICE FOR COMPENSATION FOR THE DRIFT BEHAVIOR OF A PNEUMATIC ACTUATING ELEMENT DURING OPERATION

(75) Inventor: Heiko KRESSE, Obernkirchen (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zuerich (CH)

(21) Appl. No.: 12/687,647

(22) Filed: Jan. 14, 2010

(30) Foreign Application Priority Data
Jan. 14, 2009 (DE) 10 2009 004 572.4

(51) Int. Cl. G05D 16/20; G05D 7/06; F16K 31/02

(52) U.S. Cl. 700/282; 251/129.04

(57) ABSTRACT

A method and an electronic device for compensation of the drift behavior during operation of a pneumatic actuating drive whose electropneumatic valve is operated in order to produce a control pressure in a closed control loop for position regulation of a switching element on the basis of a position regulator. A velocity profile v(t) of the switching element is recorded along the time axis during operation of the regulation, and at the same time, the opening cross-section profile A(t) of the fitting which is predetermined for the position regulator as a nominal value, is also recorded. The velocity profile v(t) and the corresponding opening cross-section profile A(t) are converted by elimination of the time to a velocity opening cross-section characteristic (v-A-characteristic). The v-A-characteristic is analyzed by pattern recognition for the presence of a braking profile which is characteristic of sealed closure, and before sealed closure, at least the last two measurement points in the braking profile are extrapolated to a point which is determined to be the opening point and is actually not zero.

### RELATED APPLICATION

This application claims priority under 35 U.S.C. §119 to German Patent Application No. 10 2009 004 572.4 filed in Germany on Jan. 14, 2009, the entire content of which is hereby incorporated by reference in its entirety.

### FIELD

The present disclosure relates to a method, an electronic device and a computer program recorded on a computer-readable recording medium for compensation of the drift behavior of a pneumatic actuating element during operation.

### BACKGROUND INFORMATION

Pneumatic actuating drives are known to include an electronic position regulator to regulate a desired opening level of a fitting, which is connected to the pneumatic actuating drive, on the basis of a predetermined nominal value. By way of example, the fitting may be a process valve within a pipeline system of a process installation. In addition, a pneumatic actuating drive can also be used for operation of other industrial fittings and the like.

The product prospectus “Der kompakte, intelligente Stellungsregler” [The compact, intelligent position regulator] (ABB Automation Products GmbH, document number: 50/18-19 DE RevA, June 2005 edition) discloses an electronic position regulator for a pneumatic actuating drive. The position regulator is in the form of a type of electronics box which can be fitted to the outside of the pneumatic actuating drive. The position regulator is a configurable appliance which can communicate, such as by means of a field bus. A functional aspect is the microprocessor-controled procedure for the regulation program. The nominal value can be preset via a field bus connection which is designed using two-conductor technology. Furthermore, the position regulator has a supply air connection for an air pressure up to a maximum of 6 bar, as well as a working connection for passing on the control pressure generated by the position regulator to the control chamber of the pneumatic position regulator.

In addition, the position regulator has an electrical sensor input for supplying the actual value of the present position of the switching element, which is operated by the pneumatic actuating drive. The actual value of the present position is obtained by means of a position sensor, which is arranged on the switching element. The pneumatic drive for the actuating drive is provided continuously by an I/P module with a downstream 3/3-way valve. The 3/3-way valve controls the passage for ventilation or venting of the actuating drive as proportionally as possible. A closed position, in which all the external connections are blocked, is assumed in a mid-position. The configuration and observation of the operating state of the position regulator can be carried out either by a built-in control panel directly in situ, or centrally via a communication interface, on the basis of a bus protocol by means of a superordinate control unit.

US 2007/0045579 A1 discloses a pneumatic position regulator which is in the form of an I/P module with a 3/3-way valve. The 3/3 switching function allows the switch positions of ventilation, closed position and venting of a working connection, which supplies the control pressure for the connected pneumatic actuating drive. The electropneumatic valve with a 3/3 switching function has two closure elements, which point in mutually opposite directions of the actuating movement and act with the same magnitude with respect to one another. Each of the closure elements bound an internal control chamber, with a common control pressure connection being associated with the two control chambers. While one closure element is used for ventilation of the working connection, the other closure element is used for venting of the working connection. When neither of the two closure elements is operated, then the valve is in the closed position in which the present control pressure of the pneumatic actuating drive does not change.

For position regulation, an electropneumatic valve is intended to provide as proportional a response as possible of the electrical drive signal with respect to the pneumatic manipulated variable of the switching element that is supplied, with disturbance variables, which are caused by the forces on the switching element of the fitting and the hysteresis, reacting on the pneumatic side. Furthermore, influencing variables such as temperature fluctuations, pressure fluctuations and the like, can disturb the ideal proportionality ratio. In order to achieve a response which is as linear as possible, the position regulator in some cases takes into account during the signal processing correction values that are determined using sensors.

Because of the disturbance variables which act on the pneumatic actuating drive, the opening point of the pneumatic actuating drive, that is to say the position point of the switching element from which the valve starts to open, must be defined and must be matched to changing constraints in order to achieve a high control quality. In other words, the signal processing must be readjusted. Fluctuating pressure and temperature conditions, in particular, continually change the opening point of the pneumatic actuating drive.

Until now, this problem has been according to known techniques by determining opening points during manufacture, with the ambient temperature at the electropneumatic valve being measured in order to use a typical coefficient for temperature compensation. However, since this completely ignores the dependence on the supply pressure, optimum linearization is not obtainable. Furthermore, an additional temperature sensor must be provided in the area of the electropneumatic valve. As an alternative to this, the supply pressure has also been measured instead of the temperature, in order to use a typical coefficient for pressure compensation. However, this ignores the dependency on temperature, as a result of which optimum linearization is likewise not obtainable. Furthermore, this technical solution requires an additional pressure sensor. In addition, both the methods explained above, in combination, have the disadvantage of requiring additional sensors.

In another known technique attempting to solve this problem, the cross section of the switching element that is actually set by the pneumatic actuating drive is determined by measurement of the position of the valve slide in the electropneumatic valve, in order to compensate for the drift behavior. However, this solution requires an additional position measurement sensor within the electropneumatic valve.

### SUMMARY

An exemplary embodiment provides a method for compensation of the drift behavior during operation of a pneumatic actuating drive whose electropneumatic valve is operated in order to produce a control pressure in a closed control loop for position regulation of a switching element on the basis of a position regulator. The exemplary method includes the following steps: a) recording a velocity profile v(t) of the switching element along the time axis during operation of the position regulation; b) at the same time as step (a), recording an opening cross-section profile A(t) of the fitting which is predetermined for the position regulator as a nominal value; c) converting the velocity profile v(t) and the corresponding opening cross-section profile A(t) by elimination of the time to obtain a velocity opening cross-section characteristic (v-A-characteristic); d) analyzing the obtained v-A-characteristic by pattern recognition for the presence of a braking profile which is a characteristic of sealed closure; and e) extrapolating, before sealed closure, at least the last two measurement points in the braking profile to a point which is determined to be the opening point and is not zero.

An exemplary embodiment provides an electronic device for compensation of the drift behavior during operation of a pneumatic actuating drive. The exemplary electronic device includes a position regulator configured to operate an electropneumatic valve in order to produce a control pressure in a closed control loop for position regulation of a switching element. The position regulator is configured to record a velocity profile (vt) of the switching element along the time axis, and at the same time, record an opening cross-section profile (At), which is predetermined as a nominal value, of the fitting, during operation of the regulation. The position regulator is configured to convert the velocity profile v(t) and the corresponding opening cross-section profile A(t) to a velocity opening cross-section characteristic (v-A-characteristic) by elimination of the time, and analyze the v-A characteristic by pattern recognition, for the presence of a braking profile which is characteristic of sealed closure, in order to extrapolate at least the last two measurement points up to a point which is determined as the opening point of the switching element and is not yet zero, before sealed closure in the braking profile.

An exemplary embodiment provides a computer-readable recording medium having a computer program recorded thereon that causes a computer to compensate for the drift behavior during operation of a pneumatic actuating drive whose electropneumatic valve is operated in order to produce a control pressure in a closed control loop for position regulation of a switching element on the basis of a position regulator. The program causes the computer to execute operations including: a) recording a velocity profile v(t) of the switching element along the time axis during operation of the position regulation; b) at the same time as operation (a), recording an opening cross-section profile A(t) of the fitting which is predetermined for the position regulator as a nominal value; c) converting the velocity profile v(t) and the corresponding opening cross-section profile A(t) by elimination of the time to obtain a velocity opening cross-section characteristic (v-A-characteristic); d) analyzing the obtained v-A-characteristic by pattern recognition for the presence of a braking profile which is a characteristic of sealed closure; and e) extrapolating, before sealed closure, at least the last two measurement points in the braking profile to a point which is determined to be the opening point and is not zero.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a schematic side view of an exemplary pneumatic actuating drive for a fitting, and

FIG. 2 shows an illustration, in the form of a graph, in order to illustrate the compensation of the drift behavior according to an exemplary embodiment of the present disclosure, and

FIG. 3 shows an illustration, in the form of a graph, in order to illustrate the compensation of the drift behavior according to an exemplary embodiment of the present disclosure.

### DETAILED DESCRIPTION

Exemplary embodiments of the present disclosure provide a method and an electronic device for compensation of the drift behavior of a pneumatic actuating drive, which is able to act effectively during operation, without any additional sensor complexity.

Exemplary embodiments of the present disclosure provide a method in which the velocity profile v(t) of the switching element is recorded along the time axis during operation of the regulation, and at the same time, the opening cross-section profile A(t) of the fitting which is predetermined for the position regulator as a nominal value, is also recorded. The velocity profile v(t) and the corresponding opening cross-section profile A(t) are then converted by elimination of the time to a velocity opening cross-section characteristic (v-A-characteristic). This v-A characteristic can then be analyzed by pattern recognition for the presence of a braking profile which is characteristic of sealed closure. Before sealed closure at least the last two measurement points in this braking profile are extrapolated to a point which is considered to be the opening point and is actually not zero.

In other words, the extrapolation is carried out as far as a point which is defined as the opening point and does not lie on the zero line of the v-A characteristic, but in front of it. If the opening point were to be on the zero line, then this would indicate the stationary state.

An advantageous feature of the present disclosure is that the opening point estimated in this way can be chosen to be slightly outside the sensor noise of the position sensor. The v-A characteristic determined according to exemplary embodiments of the present disclosure provides the basis for precise analysis of the drift behavior.

In order to eliminate random disturbance influences in the signal-processing method according to exemplary embodiments of the present disclosure, one measure which represents an improvement of the present disclosure provides that the difference in the opening points, which can be determined by extrapolation, is added up by means of an integrating low-pass filter. The opening point estimated by extrapolation is therefore not simply adopted by the regulation but is passed to the low-pass filter in order to preclude serious incorrect reactions, which are otherwise possible, of the regulation, for example remaining stationary.

The characteristic braking profile, on which the pattern recognition is based, can be obtained from slowly continuous inward movement of the switching element until sealed closure of the fitting. Inward moving of the switching element at excessively fast speed in comparison thereto would nevertheless be ignored as an abnormal behavior of the switching element for analysis of the drift behavior. It is possible to determine whether the braking of the switching element is dominated, for example, by static friction or the mass inertia.

A further measure, which represents an improvement of the present disclosure, is that the position regulator monitors the time within which a movement of the switching element occurs after electrical operation of the electropneumatic valve. The monitoring ensures that the opening point is not too small, and the signal processing can also take account of the static friction within the pneumatic actuating drive. If the time that is found is too long, then it is possible to pass a positive difference to the low-pass filter, thus resulting in an increase in the manipulated variable.

The exemplary method described above can be implemented by a computer processing device executing a computer program product as a routine for compensation of the drift behavior, which is implemented by appropriate control commands executed by the computer processing device. The computer program product can be recorded on a computer-readable recording medium and be executed as software by an electronic regulation unit. For this purpose, the electronic regulation unit has at least one microprocessor with a connected memory unit for storing the software, as well as at least the parameters which influence the process. The electronic regulation unit, which can be a component of the closed control loop of the pneumatic actuating drive, can be incorporated as a position regulator in an electronic device, such as by being fitted directly to the pneumatic drive for operation of a fitting which is coupled thereto.

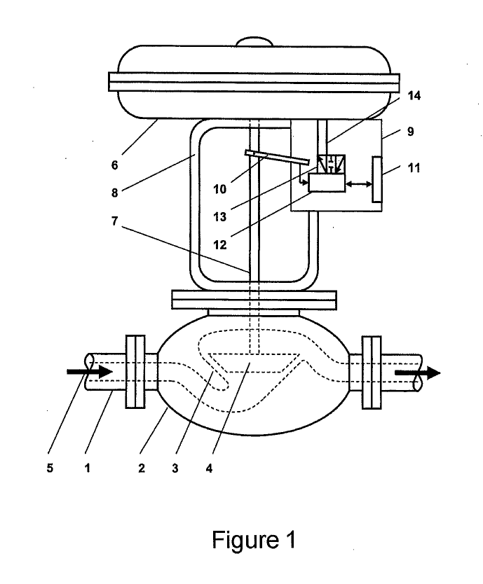

FIG. 1 shows a schematic side view of an exemplary pneumatic actuating drive for a fitting. In the exemplary embodiment illustrated in FIG. 1, an electronpneumatic valve of a pneumatic actuating drive is operated to produce a control pressure in a closed control loop for position regulation of a switching element on the basis of a position regulator. In particular, as shown in the exemplary embodiment of FIG. 1, a fitting 2 is installed in a pipeline 1 of a process installation. According to an exemplary embodiment, the fitting 2 can be in the form of a process valve with a seat structure. In its interior, the fitting 2 has a closing body 4, which interacts with a valve seat 3, in order to control the amount of process medium 5 passing through the fitting 2. The closing body 4 can be operated linearly, as a pushrod, for example, by a pneumatic actuating drive 6 via a switching element 7. The pneumatic actuating drive 6 is firmly connected to the fitting 2 via a yoke 8. A position regulator 9 in the form of an electronic module is also attached to the yoke 8.

The travel (displacement) of the switching element 7 is detected and signaled to the position regulator 9 by means of a position sensor 10 which is associated with the position regulator 9. The detected travel is compared for normal operation with a nominal value, which is supplied from the exterior and is stored in a memory unit 11 (e.g., a computer-readable recording medium, such as a non-volatile and/or volatile memory), by means of a regulation unit 12, and the actuating drive 6 is driven as a function of the determined control error. The regulation unit 12 of the position regulator 9 has an electropneumatic valve 13 as an I/P converter for conversion of an electrical control error to an adequate control pressure. The electropneumatic valve 13 of the regulation unit 12 is connected to the actuating drive 6 via a pressure medium supply 14. An internal switching membrane, which operates the switching element 7, within the actuating drive 6 is acted on by the control pressure which is supplied via the pressure medium supply 19.

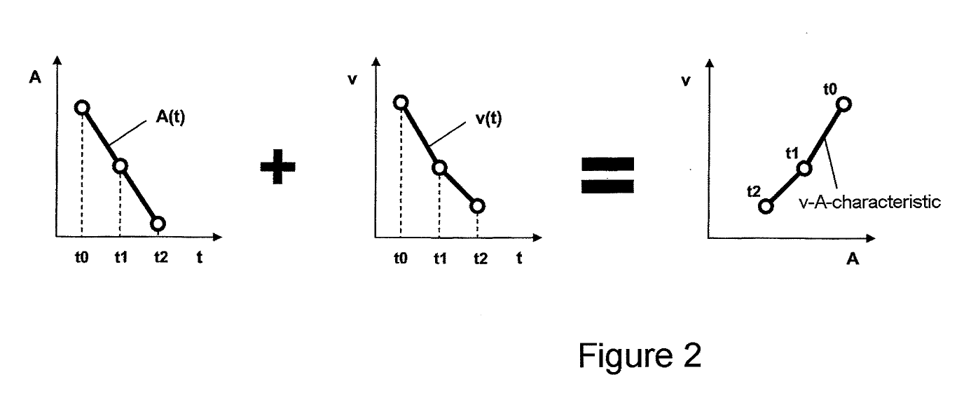

In order to compensate for the drift behavior of a pneumatical actuating element during operation of the pneumatic actuating drive 6, the position regulator 9, as shown in FIG. 2, records the time profile of the velocity v(t) of the switching element 7 along the time axis, and at the same time also records the corresponding opening cross-section profile A(t), which is predetermined as a nominal value, of the fitting 2. A velocity opening cross-section characteristic (v-A characteristic) is then obtained by elimination of the time from the velocity profile v(t) as well as the corresponding opening cross-section profile A(t), from which the position regulator 6 analyzes the v-A characteristic, by pattern recognition, for the presence of a braking profile which is a characteristic of sealed closure.

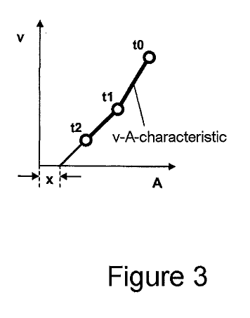

If a characteristic braking profile is identified, then, as shown in FIG. 3, at least the last two measurement points before sealed closure are extrapolated to a point which is regarded as the opening point of the switching element 7 and is not yet zero at the position X. The opening point obtained in this way can in this way be determined to be free of disturbance variables, in order to achieve high control quality.

The position regulator 9, position sensor 10 and regulation unit 12 were each described above with reference to the respective functions they perform according to an exemplary embodiment. It is to be understood that one or more these elements can be implemented in a hardware configuration. For example, the respective components can comprise a computer processor configured to execute computer-readable instructions (e.g., computer-readable software), a non-volatile computer-readable recording medium, such as the memory element 11, configured to store such computer-readable instructions, and a volatile computer-readable recording medium (e.g., RAM) configured to be utilized by the computer processor as working memory while executing the computer-readable instructions. The position regulator 9, position sensor 10 and regulation unit 12 may also be configured to sense, generate and/or operate in accordance with analog signals, digital signals and/or a combination of digital and analog signals to carry out their intended functions.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline

2 Fitting

3 Valve seat

4 Closing body

5 Process medium

6 Actuating drive

7 Switching element

8 Yoke

9 Position regulator

10 Position sensor

11 Memory unit

12 Regulation unit

13 Valve

14 Pressure medium supply

x Position

p Pressure

What is claimed is:

1. A method for compensation of the drift behavior during operation of a pneumatic actuating drive whose electropneumatic valve is operated in order to produce a control pressure in a closed control loop for position regulation of a switching element on the basis of a position regulator, the method comprising the following steps:
a) recording a velocity profile v(t) of the switching element along the time axis during operation of the position regulation;
b) at the same time as step (a), recording an opening cross-section profile A(t) of the fitting which is predetermined for the position regulator as a nominal value;
c) converting the velocity profile v(t) and the corresponding opening cross-section profile A(t) by elimination of the time to obtain a velocity opening cross-section characteristic (v-A-characteristic);
d) analyzing the obtained v-A-characteristic by pattern recognition for the presence of a braking profile which is a characteristic of sealed closure; and
e) extrapolating, before sealed closure, at least the last two measurement points in the braking profile to a point which is determined to be the opening point and is not zero.

2. The method as claimed in claim 1, comprising determining a difference in the opening point by extrapolation, and adding the determined difference in the opening point by an integrating low-pass filter, to eliminate random disturbance influences.

3. The method as claimed in claim 1, comprising obtaining the characteristic braking profile from slowly continuous inward movement of the switching element until sealed closure of the fitting.

4. The method as claimed in claim 1, wherein the point which is determined by extrapolation and is actually not zero is defined as a point which is outside the signal noise of the position sensor.

5. The method as claimed in claim 1, wherein the position regulator monitors the time within which a movement of the switching element occurs after electrical operation of the electropneumatic valve.

6. An electronic device for compensation of the drift behavior during operation of a pneumatic actuating drive, the electronic device comprising a position regulator configured to operate an electropneumatic valve in order to produce a control pressure in a closed control loop for position regulation of a switching element,
wherein the position regulator is configured to record a velocity profile (vt) of the switching element along the time axis, and at the same time, record an opening cross-section profile (At), which is predetermined as a nominal value, of the fitting, during operation of the regulation, and
wherein the position regulator is configured to convert the velocity profile v(t) and the corresponding opening cross-section profile A(t) to a velocity opening cross-section characteristic (v-A-characteristic) by elimination of the time, and analyze the v-A characteristic by pattern recognition, for the presence of a braking profile which is characteristic of sealed closure, in order to extrapolate at least the last two measurement points up to a point which is determined as the opening point of the switching element and is not yet zero, before sealed closure in the braking profile.

7. The electronic device as claimed in claim 6, wherein, the position regulator is configured to record the velocity profile v(t) and the opening cross-section profile A(t) in a memory element.

8. The electronic device as claimed in claim 6, wherein the electopneumatic valve is in the form of a 3/3-way valve with the switch positions of venting, ventilation and closed position.

9. A computer-readable recording medium having a computer program recorded thereon that causes a computer to compensate for the drift behavior during operation of a pneumatic actuating drive whose electropneumatic valve is operated in order to produce a control pressure in a closed control loop for position regulation of a switching element on the basis of a position regulator, the program causing the computer to execute operations comprising:
a) recording a velocity profile v(t) of the switching element along the time axis during operation of the position regulation;
b) at the same time as operation (a), recording an opening cross-section profile A(t) of the fitting which is predetermined for the position regulator as a nominal value;
c) converting the velocity profile v(t) and the corresponding opening cross-section profile A(t) by elimination of the time to obtain a velocity opening cross-section characteristic (v-A-characteristic);
d) analyzing the obtained v-A-characteristic by pattern recognition for the presence of a braking profile which is a characteristic of sealed closure; and
e) extrapolating, before sealed closure, at least the last two measurement points in the braking profile to a point which is determined to be the opening point and is not zero.

10. A computer-readable recording medium as claimed in claim 9, wherein the computer is communicatively connected to a position regulation unit of a pneumatic actuating drive for operation of the fitting.

11. The method as claimed in claim 2, wherein the point which is determined by extrapolation and is actually not zero is defined as a point which is outside the signal noise of the position sensor.

12. The method as claimed in claim 2, wherein the position regulator monitors the time within which a movement of the switching element occurs after electrical operation of the electropneumatic valve.

13. The electronic device of claim 7, wherein the memory element is in the form of a ring buffer.

14. The electronic device of claim 7, wherein the memory element is a computer-readable recording medium.
